(19) United States
(12) Patent Application Publication
(10) Pub. No.: US 2020/0064478 A1
(43) Pub. Date: Feb. 27, 2020

(54) METHOD FOR DEPTH IMAGING BASED ON OPTICAL QUADRANT DETECTION SCHEME

(71) Applicant: GM GLOBAL TECHNOLOGY OPERATIONS LLC, Detroit, MI (US)

(72) Inventors: Emanuel Mordechai, Mishmarot (IL); Tzvi Philipp, Beit Shemesh (IL)

(21) Appl. No.: 16/108,990

(22) Filed: Aug. 22, 2018

(51) Int. Cl. G01S 17/42; G01S 17/89; G01S 17/10

(52) U.S. Cl. CPC G01S 17/42; G01S 17/107; G01S 17/89

(57) ABSTRACT

A vehicle, Lidar system and method of imaging a field of interest. A laser illuminates a field of interest with a source pulse of light. A quadrant detector receives a reflected pulse that is a reflection of the source pulse from the field of interest. A processor determine a three-dimensional image of the field of interest from a location of the reflected pulse at the quadrant detector and a time-of-flight for the reflected pulse. The processor further navigates the vehicle through the field of interest using the three-dimension image.

The subject disclosure relates to Lidar systems and, in particular, to a method for depth imaging using a Lidar system using an optical quadrant detector.

A Lidar system can be used in a vehicle in order to aid in navigation of the vehicle. Often the Lidar system includes a mechanical system for orienting the light across a field of view. The resolution of such images is therefore limited to the scanning rates of such mechanical systems. Additionally, such systems usually require relatively long pulses of light. Such systems generally require arrays of sensors in two dimensions, whose number of sensing pixels limits the system resolution. There is therefore a concern that such pulses may approach or exceed eye-safety limitations. Accordingly, it is desirable to provide a Lidar system for determining depth and angular parameters for targets in a field of view without the use of mechanical scanning devices and with reduced pulse duration and power.

### SUMMARY

In one exemplary embodiment, a method of imaging a field of interest is disclosed. The method includes illuminating, via a laser, a field of interest with a source pulse of light, receiving, at a quadrant detector, a reflected pulse that is a reflection of the source pulse from the field of interest, and determining a three-dimensional image of the field of interest from a location of the reflected pulse at the quadrant detector and a time-of-flight for the reflected pulse.

In addition to one or more of the features described herein, the method further includes sampling the reflected pulse a plurality of times at the quadrant detector to determine a parameter of the field of interest at a plurality of depths within the field of interest. The method further includes determining an angular location of a target within the field of interest from the location of the reflected pulse at the quadrant detector. The method further includes determining the location of the reflected pulse at the quadrant detector by comparing light intensities at quadrants of the quadrant detector. The method further includes determining a depth of a target within the field of interest from a time of flight associated with the reflected pulse. The method further includes synchronizing the laser with the quadrant detector. The method further includes navigating a vehicle through the field of interest using the three-dimensional image.

In another exemplary embodiment, a Lidar system is disclosed. The Lidar system includes a laser, a quadrant detector and a processor. The laser is configured to illuminate a field of interest with a source pulse of light. The quadrant detector is configured to receive a reflected pulse that is a reflection of the source pulse from the field of interest. The processor is configured to determine a three-dimensional image of the field of interest from a location of the reflected pulse at the quadrant detector and a time-of-flight for the reflected pulse.

In addition to one or more of the features described herein, the quadrant detector samples the reflected pulse a plurality of times to determine a parameter of the field of interest at a plurality of depths within the field of interest. The processor is further configured to determine an angular location of a target within the field of interest from the location of the reflected pulse at the quadrant detector. The processor is further configured to determine the location of the reflected pulse at the quadrant detector by a comparing light intensities at the quadrants of the quadrant detector. The processor is further configured to determine a depth of a target within the field of interest from a time of flight associated with the reflected pulse. A laser driver synchronizes the laser with the quadrant detector. A spatial modulator configured to filters out signals arising from two or more targets that are at a same distance from the quadrant detector and that are angularly distinguishable.

In yet another exemplary embodiment, a vehicle is disclosed. The vehicle includes a laser, a quadrant detector and a processor. The laser is configured to illuminate a field of interest with a source pulse of light. The quadrant detector is configured to receive a reflected pulse that is a reflection of the source pulse from the field of interest. The processor is configured to determine a three-dimensional image of the field of interest from a location of the reflected pulse at the quadrant detector and a time-of-flight for the reflected pulse, and navigate the vehicle through the field of interest using the three-dimension image.

In addition to one or more of the features described herein, the quadrant detector samples the reflected pulse a plurality of times to determine a parameter of the field of interest at a plurality of depths within the field of interest. The processor is further configured to determine an angular location of a target within the field of interest from the location of the reflected pulse at the quadrant detector. The processor is further configured to determine the location of the reflected pulse at the quadrant detector by a comparing light intensities at the quadrants of the quadrant detector. The processor is further configured to determine a depth of a target within the field of interest from a time of flight associated with the reflected pulse. A laser driver that synchronizes the laser with the quadrant detector.

The above features and advantages, and other features and advantages of the disclosure are readily apparent from the following detailed description when taken in connection with the accompanying drawings.

### BRIEF DESCRIPTION OF THE DRAWINGS

Other features, advantages and details appear, by way of example only, in the following detailed description, the detailed description referring to the drawings in which:

FIG. 1 shows an autonomous vehicle including a Lidar system according to an embodiment;

FIG. 2 discloses an optical quadrant detector suitable for use in the Lidar system of FIG. 1;

FIG. 3 shows a detailed view of the Lidar system;

FIG. 4 shows an illustrative source pulse generated by the laser of the Lidar system;

FIG. 5 shows an illustrative reflected pulse formed by reflection of the source pulse from a target in a field of interest of the Lidar system;

FIG. 6 illustrates various range-dependent intensity measurements obtained at the quadrants of the optical quadrant detector; and

FIG. 7 shows an illustrative depth image that can be formed using values of the parameters determined using the Lidar system.

### DETAILED DESCRIPTION

The following description is merely exemplary in nature and is not intended to limit the present disclosure, its application or uses. It should be understood that throughout the drawings, corresponding reference numerals indicate like or corresponding parts and features.

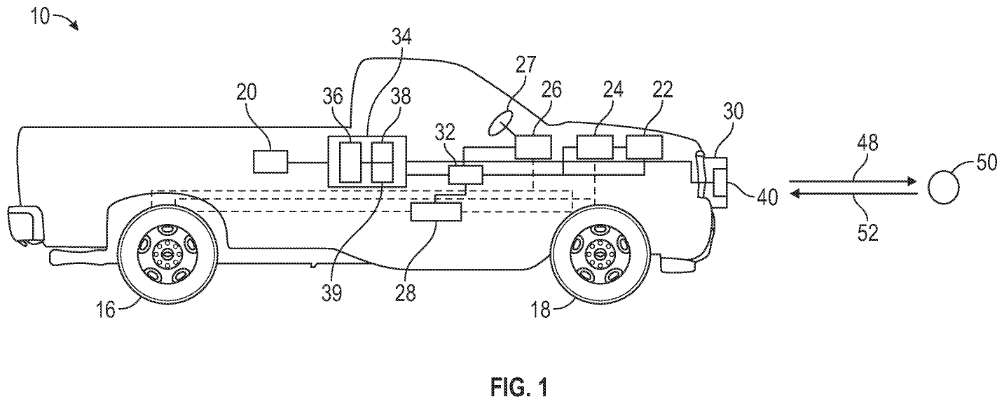

In accordance with an exemplary embodiment, FIG. 1 shows an autonomous vehicle 10. In an exemplary embodiment, the autonomous vehicle 10 is a so-called Level Four or Level Five automation system. A Level Four system indicates “high automation”, referring to the driving mode-specific performance by an automated driving system of all aspects of the dynamic driving task, even if a human driver does not respond appropriately to a request to intervene. A Level Five system indicates “full automation”, referring to the full-time performance by an automated driving system of all aspects of the dynamic driving task under all roadway and environmental conditions that can be managed by a human driver.

The autonomous vehicle 10 generally includes at least a navigation system 20, a propulsion system 22, a transmission system 24, a steering system 26, a brake system 28, a sensor system 30, an actuator system 32, and a controller 34. The navigation system 20 determines a trajectory plan for automated driving of the autonomous vehicle 10. The propulsion system 22 provides power for creating a motive force for the autonomous vehicle 10 and may, in various embodiments, include an internal combustion engine, an electric machine such as a traction motor, and/or a fuel cell propulsion system. The transmission system 24 is configured to transmit power from the propulsion system 22 to wheels 16 and 18 of the autonomous vehicle 10 according to selectable speed ratios. The steering system 26 influences a position of the wheels 16 and 18. While depicted as including a steering wheel 27 for illustrative purposes, in some embodiments contemplated within the scope of the present disclosure, the steering system 26 may not include a steering wheel 27. The brake system 28 is configured to provide braking torque to the wheels 16 and 18.

The sensor system 30 includes a Lidar system 40 that senses targets in an exterior environment of the autonomous vehicle 10 and provides a depth image of the environment. In operation, the Lidar system 40 sends out a source pulse of light 48 that is reflected back at the autonomous vehicle 10 by one or more targets 50 in the field of view of the Lidar system 40 as a reflected pulse 52.

The actuator system 32 includes one or more actuators that control one or more vehicle features such as, but not limited to, the propulsion system 20, the transmission system 22, the steering system 24, and the brake system 26.

The controller 34 includes a processor 36 and a computer readable storage device or media 38. The computer readable storage medium includes programs or instructions 39 that, when executed by the processor 36, operate the Lidar system 40 in order to obtain data such as location and depth data of a target 50. The computer readable storage medium 38 may further include programs or instructions 39 that when executed by the processor 36, operate the navigation system 20 and/or the actuator system 32 according to data obtained from the Lidar system 40 in order to navigate the autonomous vehicle 10 with respect to the target 50.

In various embodiments the controller 34 operates the Lidar system 40 in order to determine a parameter such as angular location and depth of the target 50 from reflected pulse 52. These parameters can be used either alone or in combination with other parameters (e.g., Doppler) to obtain a predictive map of the environment for navigational purposes. The navigation system 20 builds a trajectory for the autonomous vehicle 10 based on data from the Lidar system 40 and any other parameters. The controller 34 can provide the trajectory to the actuator 32 to control the propulsion system 20, transmission system 22, steering system 24 and/or brake 26 in order to navigate the vehicle 10 with respect to the target 50.

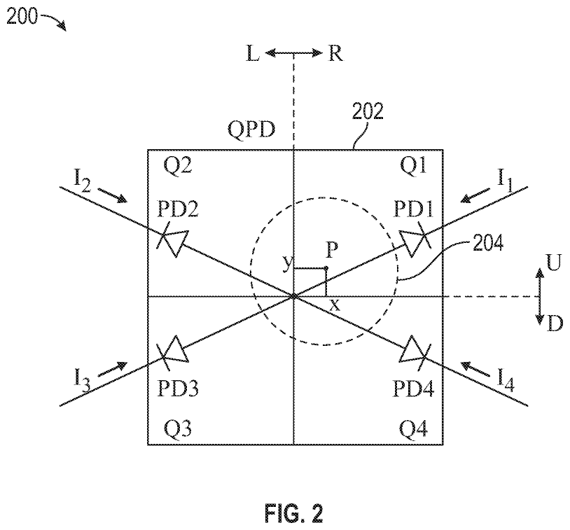

FIG. 2 discloses an optical quadrant detector 200 suitable for use in the Lidar system 40 of FIG. 1. The optical quadrant detector 200 includes a sensitive region 202 including a plurality of photodiodes PD₁, PD₂, PD₃, PD₄, which define four different quadrants Q₁, Q₂, Q₃, Q₄, respectively. The grouping of the photodiodes into quadrants enables the optical quadrant detector 200 to be able to determine a location at which a beam of light, such as reflected pulse 52, is incident on the optical quadrant detector 200. More particular, the optical quadrant detector 200 is able to determine a location of a central point P of the reflected pulse 52. When at least a portion of the reflected pulse 52 illuminates a given quadrant, the photodiodes of the quadrant generate a current having a magnitude proportional to the intensity of the light incident in the quadrant. Quadrants Q₁, Q₂, Q₃ and Q₄ generate associated current I₁, I₂, I₃ and I₄, respectively. The currents I₁, I₂, I₃ and I₄ can be used to determine the location of the reflected pulse 52 within the sensitive region 202.

An x-coordinate of a center of the reflected pulse 52 can be determined by comparing the current generated by light incident on the right half (I_{R}) of the optical quadrant detector 200 (i.e., Quadrants Q1 and Q4) to the current generated by light incident on the left half (I_{L}) of the optical quadrant detector 200 (i.e., Quadrants Q2 and Q3), as expressed in Eq. (1):

$$X = {k}_{x} \frac{{I}_{R} - {I}_{L}}{{I}_{R} + {I}_{L}} \qquad Eq . ( 1 )$$

where I_{R}=I₁+I₄ and I_{L}=I₂+I₃. Expressed as a time-varying variable, the x-coordinate is given (in terms of the quadrant currents I₁, I₂, I₃ and I₄) by:

$$X ( t ) = {k}_{x} \frac{[ {I}_{1} ( t ) + {I}_{4} ( t ) ] - [ {I}_{2} ( t ) + {I}_{3} ( t ) ]}{[ {I}_{1} ( t ) + {I}_{4} ( t ) ] + [ {I}_{2} ( t ) + {I}_{3} ( t ) ]} \qquad Eq . ( 2 )$$

Similarly, the y-coordinate of the center of the beam of light 204 can be determined by comparing the current generated by light incident on the upper half (I_{U}) of the optical quadrant detector 200 (i.e., Quadrants Q1 and Q2) to the current generated by light incident on the lower half (I_{D}) of the optical quadrant detector 200 (i.e., Quadrants Q3 and Q4), as expressed by Eq. (3):

$$Y = {k}_{y} \frac{{I}_{U} - {I}_{D}}{{I}_{U} + {I}_{D}} \qquad Eq . ( 3 )$$

where I_{U}=I₁+I₂ and I_{D}=I₃+I₄. Expressed as a time-varying variable, the y-coordinate is given (in terms of the quadrant currents I₁, I₂, I₃ and I₄) by:

$$Y ( t ) = {k}_{y} \frac{[ {I}_{1} ( t ) + {I}_{2} ( t ) ] - [ {I}_{3} ( t ) + {I}_{4} ( t ) ]}{[ {I}_{1} ( t ) + {I}_{2} ( t ) ] + [ {I}_{3} ( t ) + {I}_{4} ( t ) ]} \qquad Eq . ( 4 )$$

In various embodiments, the optical quadrant detector 200 has a high degree of position or angular resolution. This resolution can be less than 0.01 degrees in various embodiments. The optical quadrant detector 200 further demonstrates a wide spectral response over the visible, near infrared (NIR), short wave infrared (SWIR), medium wavelength infrared (MWIR) and long wave infrared (LWIR) regions of the electromagnetic spectrum. The optical quadrant detector 200 can be composed of Silicon, Germanium, InGaAs, Mercury Cadmium Telluride (MCT) or other suitable materials. The optical quadrant detector 200 has a quick response rate in comparison to a duration of a reflected pulse 52 received at the optical quadrant detector 200.

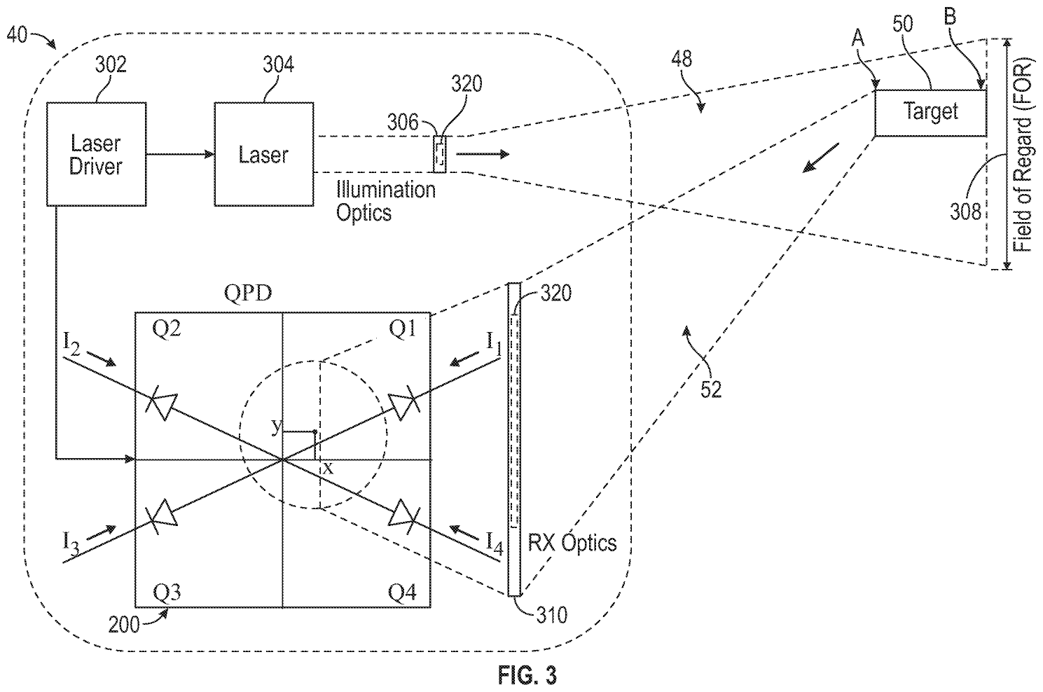

When used in the Lidar system 40, the x-coordinate and y-coordinate of the reflected pulse 52 can be used to determine an angular location of the target 50 that produces the reflected pulse 52 as well as a depth image of the target 50, as discussed below with respect to FIGS. 3-7.

FIG. 3 shows a detailed view of the Lidar system 40 of FIG. 1. The Lidar system 40 generates a source pulse 48 using various illumination equipment such as a laser driver 302, a laser 304 and illumination optics 306. The laser driver 302 actuates the laser 304 to produce a pulse of light having a selected time duration. The light from the laser 304 passes through the illumination optics 306, which can be a divergent lens in various embodiments. The illumination optics 306 angularly spreads the laser light over a selected field of interest 308 to form the source pulse 48. The angular extent of the source pulse 48 defines a field of interest 308 for the Lidar system 40.

The Lidar system 40 further includes receiver equipment that includes receiver optics 310 and the optical quadrant detector 200 of FIG. 2. The source pulse 48 is reflected from the target 50 and/or other targets in the field of interest 308 to form reflected pulse 52. The reflected pulse 52 is directed towards receiver optics 310. The receiver optics 310 focuses the reflected pulse 52 onto the optical quadrant detector 200. The optical quadrant detector 200 is synchronized with the laser 304 by a synchronization pulse sent to the optical quadrant detector 20 by the laser driver 302 upon sending a signal to the laser 304 to generate a pulse of light. With the laser 304 synchronized to the optical quadrant detector 200, at least a time of arrival or time-of-flight (TOF) of the reflected pulse 52 can be determined.

In an additional embodiment, the illumination optics 306, the receiver optics 310 or both can include a spatial modulator 320. The spatial modulator 320 can be used to filter out signals arising from two or more targets or objects 50 that are at a same distance from the Lidar system 40 or optical quadrant detector 200 and that are angularly distinguishable.

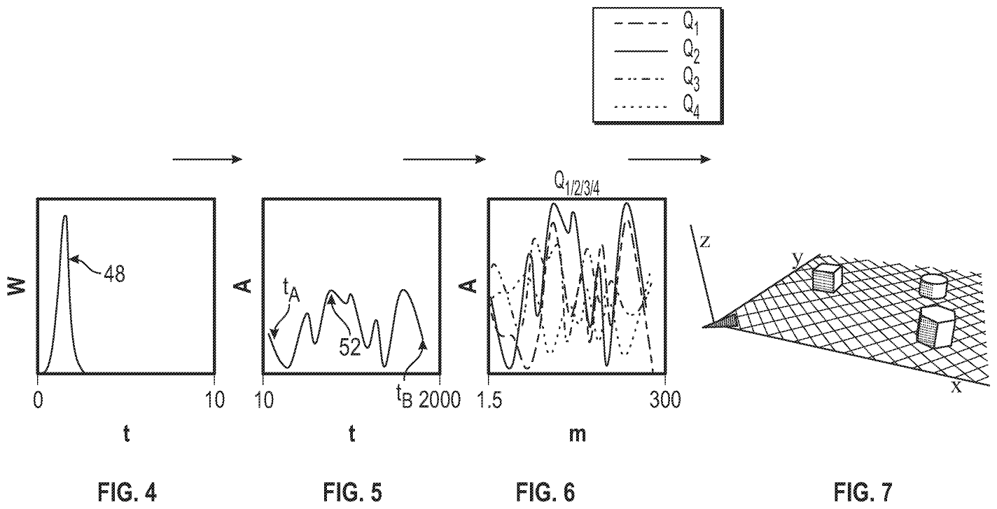

FIG. 4 shows an illustrative source pulse 48 generated by the laser 302 of the Lidar system 40. The source pulse 48 is a pulse having a selected pulse duration. In various embodiments, the source pulse 48 is from about 1 nanosecond (ns) to about 5 ns in duration. In the illustrative example of FIG. 4, the source pulse 48 is initiated at time t=0 and ends at about time t=2 nanoseconds, with a peak at about 1 nanosecond.

FIG. 5 shows an illustrative reflected pulse 52 formed by reflection of the source pulse 48 from target 50 in the field of interest 308 of the Lidar system 40. The reflected pulse 52 is spread out in time in comparison to the source pulse 48. In FIG. 5 the illustrative reflected pulse 52 is spread over a time length from about t=10 ns to about t=2000 ns. The time-spreading of the reflected pulse 52 is due to the reflection of the source pulse 48 off of surfaces of the target 50 at different depths of the target 50. A depth of the reflective surface is related to a range of the reflective surface with respect to the Lidar system 40. Referring to FIG. 3 for illustration, the source pulse 48 reflects from surface A of target 50 before reflecting off of surface B of target 50. Referring back to FIG. 5, the time of arrival of the reflection from surface A occurs at time to while the time of arrival of the reflection from surface B occurs at time t_{B}. The difference in the depth, or distance between surface A and surface B in a direction parallel to the direction of the source pulse 48 is therefore translated into a time difference of the reflection beam 52 at the optical quadrant detector 200.

It is noted that the optical quadrant detector 200 has a quick sampling response time in comparison to the time duration of the reflected pulse 52. In various embodiments, the response of the optical quadrant detector 200 is less than a few 100 picoseconds. Therefore, the optical quadrant detector 200 can sample the reflected pulse 52 multiple times throughout the duration of the reflected pulse 52. Each sample of the reflected pulse 52 provides information at a reflective surface at a selected depth of the target 50, an angular location of the reflective surface and an intensity of light at the particular depth. A plurality of samples of these parameters can therefore be used to build a depth image of the field of interest 308

FIG. 6 illustrates various range-dependent intensity measurements obtained at the quadrants of the optical quadrant detector 200. Due to the multiple reflective surfaces in the field of interest 50, each time the optical quadrant detector 200 samples the reflected pulse 52, the intensity at each quadrant changes. The optical quadrant detector 200 determines time-dependent x(t) and y(t) coordinates. The time of the x and y coordinates is related to the time of flight (TOF) of the reflected pulse 52, which is related to range by Eq. (5):

r=c×TOF/2 Eq. (5)

where r is the range of the target and c is the speed of light. Thus, the time-dependent coordinates x(t) and y(t) can be rewritten to be dependent upon range or depth measurements. FIG. 6 shows the light intensities as a function of a range variable for each of the four quadrants of the optical quadrant detector 200.

FIG. 7 shows an illustrative depth image that can be formed using values of parameters determined using the Lidar system 40 disclosed herein. The x and y coordinates are used to determine angular information of the field of interest 308 in terms of elevation θ, azimuth φ as well in range R and intensity I, as expressed in Eq. (6):

$$[ x ( t ) , y ( t ) ] {}^{R = \frac{c \times ToF}{2}} [ x ( R ) , y ( R ) ] -> {P}_{n} \{ θ , φ , R , I \} \qquad Eq . ( 6 )$$

The image determined from the Lidar system can be provided to the navigation system 20, FIG. 1 of the vehicle 10 in order to aid in navigation of the vehicle with respect to the target 50.

While the above disclosure has been described with reference to exemplary embodiments, it will be understood by those skilled in the art that various changes may be made and equivalents may be substituted for elements thereof without departing from its scope. In addition, many modifications may be made to adapt a particular situation or material to the teachings of the disclosure without departing from the essential scope thereof. Therefore, it is intended that the present disclosure not be limited to the particular embodiments disclosed, but will include all embodiments falling within the scope thereof.

What is claimed is:

1. A method of imaging a field of interest, comprising:
illuminating, via a laser, a field of interest with a source pulse of light;
receiving, at a quadrant detector, a reflected pulse that is a reflection of the source pulse from the field of interest; and
determining a three-dimensional image of the field of interest from a location of the reflected pulse at the quadrant detector and a time-of-flight for the reflected pulse.

2. The method of claim 1, further comprising sampling the reflected pulse a plurality of times at the quadrant detector to determine a parameter of the field of interest at a plurality of depths within the field of interest.

3. The method of claim 2, wherein the parameter is an angular location of a target within the field of interest, further comprising determining the angular location from the location of the reflected pulse at the quadrant detector.

4. The method of claim 3, further comprising determining the location of the reflected pulse at the quadrant detector by comparing light intensities at quadrants of the quadrant detector.

5. The method of claim 2, wherein the parameter is a depth of a target within the field of interest, further comprising determining the depth from a time of flight associated with the reflected pulse.

6. The method of claim 1, further comprising synchronizing the laser with the quadrant detector.

7. The method of claim 1, further comprising navigating a vehicle through the field of interest using the three-dimensional image.

8. A Lidar system, comprising:
a laser configured to illuminate a field of interest with a source pulse of light;
a quadrant detector configured to receive a reflected pulse that is a reflection of the source pulse from the field of interest; and
a processor configured to determine a three-dimensional image of the field of interest from a location of the reflected pulse at the quadrant detector and a time-of-flight for the reflected pulse.

9. The Lidar system of claim 8, wherein the quadrant detector samples the reflected pulse a plurality of times to determine a parameter of the field of interest at a plurality of depths within the field of interest.

10. The Lidar system of claim 9, wherein the parameter is an angular location of a target within the field of interest and the processor is further configured to determine the angular location from the location of the reflected pulse at the quadrant detector.

11. The Lidar system of claim 10, wherein the processor is further configured to determine the location of the reflected pulse at the quadrant detector by a comparing light intensities at the quadrants of the quadrant detector.

12. The Lidar system of claim 9, wherein the parameter is a depth of a target within the field of interest and the processor is further configured to determine the depth from a time of flight associated with the reflected pulse.

13. The Lidar system of claim 8, further comprising a laser driver that synchronizes the laser with the quadrant detector.

14. The Lidar system of claim 8, further comprising a spatial modulator configured to filters out signals arising from two or more targets that are at a same distance from the quadrant detector and that are angularly distinguishable.

15. A vehicle, comprising:
a laser configured to illuminate a field of interest with a source pulse of light;
a quadrant detector configured to receive a reflected pulse that is a reflection of the source pulse from the field of interest; and
a processor configured to:
determine a three-dimensional image of the field of interest from a location of the reflected pulse at the quadrant detector and a time-of-flight for the reflected pulse; and
navigate the vehicle through the field of interest using the three-dimension image.

16. The vehicle of claim 15, wherein the quadrant detector samples the reflected pulse a plurality of times to determine a parameter of the field of interest at a plurality of depths within the field of interest.

17. The vehicle of claim 16, wherein the parameter is an angular location of a target within the field of interest and the processor is further configured to determine the angular location from the location of the reflected pulse at the quadrant detector.

18. The vehicle of claim 17, wherein the processor is further configured to determine the location of the reflected pulse at the quadrant detector by a comparing light intensities at the quadrants of the quadrant detector.

19. The vehicle of claim 16, wherein the parameter is a depth of a target within the field of interest and the processor is further configured to determine the depth from a time of flight associated with the reflected pulse.

20. The vehicle of claim 15, further comprising a laser driver that synchronizes the laser with the quadrant detector.
